(19) United States
(12) Patent Application Publication
(10) Pub. No.: US 2007/0016925 A1
(43) Pub. Date: Jan. 18, 2007

(54) Interactive TV application display method and apparatus

(76) Inventors: Arthur Vaysman, San Jose, CA (US); Eduard Zaslavsky, Richmond Hill (CA)

Correspondence Address: John G. Posa;Gifford, Krass, Groh, Sprinkle,, Anderson & Citkowski, PC, PO Box 7021, Troy, MI, 48007-7021, US

(21) Appl. No.: 11/471,346

(22) Filed: Jun. 20, 2006

Related U.S. Application Data
(60) Provisional application No. 60/691,794, filed on Jun. 20, 2005.

(51) Int. Cl. H04N 5/445

(52) U.S. Cl. 725/39

(57) ABSTRACT

A system and method for accurately rendering an interactive TV application is accomplished by adjusting the contents of an on-screen buffer (OSD) to match the native physical characteristics of a target display device, preferably using fonts specific to the display device. Typically the character data is merged with graphics data and still or moving video background information and passed to the display using an analog or digital interface. Since the native resolution of the display is ideally identical to the resolution of the OSD buffer, the display device will not need to enlarge or reduce the rendering of the application. As a result, the character and graphics data will not be distorted by the display rasterizing process.

### REFERENCE TO RELATED APPLICATION

This application claims priority to U.S. Provisional Patent Application Ser. No. 60/691,794, filed Jun. 20, 2005, the entire content of which is incorporated herein by reference.

### FIELD OF THE INVENTION

The present invention relates generally to on-screen displays (OSDs) and, in particular, to apparatus and methods of displaying graphical and character-based information associated with interactive TV applications through a digital broadcasting or storage medium.

### BACKGROUND OF THE INVENTION

In recent years, interactive programs have been broadcast making practical usage of digital technologies. When the interactive program is provided on-air, an application described in Java™, HTML, etc. is usually included in the program. This application superposes information on video using graphics and/or texts for creating particular content. To execute the application, it is delivered to a TV receiver, either through a digital channel that distributes the program, or through a different delivery route such as the Internet. These functions refer to an application download or upload.

The application may be of the type that displays an advertisement, etc., which is unrelated to the program or content, at a corner of a screen on the TV receiver. Such an application is created by a vender different from a vender who creates an application for content, and the application here is independently downloaded from the content and executed on a TV receiver. Alternatively, the application may be stored in memory. Examples include an Electronic/Interactive Program Guide (EPG/IPG), or DVR/PVR applications. Such applications are typically created by TV receiver manufacturer or third parties.

In general, with interactive broadcasting, it is preferable that the application provides information along with graphics resolution corresponding to video resolution. If a graphics resolution different from the resolution for the video is used, an enlargement and reduction process needs to be executed to unify both resolution when the information is output on a display apparatus. However, when this process is executed, pixel dithering and other visual artifacts may occur, which make it difficult to render a pleasing display.

With digital video compression technologies, such as an MPEG, there is a large difference in the bandwidth necessary for data transfer if video resolution varies. To conserve digital bandwidth for data transfer it is typically necessary to broadcast a program with appropriate video resolution according to its program content.

Overall, the interplay between video resolution and graphics resolution becomes an issue. If the video resolution of a channel that has been selected up to a certain point is different from the video resolution of another channel that is newly selected, a pleasing picture cannot be expected unless these graphics are displayed with the graphics resolution respectively corresponding to each of the video resolution. The most preferable option is to use the graphics resolution equivalent to the video resolution. However, depending on the TV receiver, such graphics resolution may not be possible due to reasons such as cost. If that is the case, it is best to select the graphics resolution that can provide the most pleasing display possible.

A conventional technology for realizing selection of the graphics resolution is the HAVi specification (Home Audio Video Interoperability—http://www.havi.org/) which allows an application operated on a TV receiver to control the graphics resolution and the video resolution. In the HAVi specification, an Application Program Interface (API) is provided to control the graphics resolution in a class called an HGraphicsDevice. When the application designates ideal graphics resolution to be used, it is possible to provide and use the resolution closest to it from the graphics resolution available in the TV receiver. Graphics display materials with a resolution according to an image format are made available in advance. When the video resolution is changed, its image format is determined from video packets, and graphics display materials according to the image format are displayed. By doing so, the display materials with the same quality and in the same size can be consistently shown (See Japanese Laid-Open Patent application No. 2000-23061, Japanese Laid-Open Patent application No. 2002-247465, Japanese Laid-Open Patent application No. 10-124021, and Japanese Patent No. 3315557, for example).

However, according to the HAVi specification, the closest desired graphics resolution is simply selected from the graphics resolution available in the TV receiver. It does not take into account an ideal combination of the graphics resolution with the video resolution currently received. Moreover, when video resolution is changed, although it is possible to show the display material with the same quality and in the same size on the TV receiver, the HAVi specification does not consider the layout of the application display.

### SUMMARY OF THE INVENTION

This invention improves upon existing solutions by providing a system and method for accurately rendering an interactive TV application on display devices having different native graphics resolutions, aspect ratios, sizes, and other physical display characteristics, thereby providing enhanced appeal, clarity, and fidelity. The invention may be used for interactive program development, testing, distribution, and so forth, without significantly increasing development costs, application distribution bandwidth, memory requirements or processing power.

In accordance with the invention, the rendering of an interactive TV application is done by adjusting the contents of an on-screen buffer (OSD) to match the native physical characteristics of a target display device. In the preferred embodiment, the system and method use display-specific fonts to render character data. The character data is merged with graphics data and still or moving video background information and passed to the display using an analog or digital interface. Since the native resolution of the display is ideally identical to the resolution of the OSD buffer, the display device will not need to enlarge or reduce the rendering of the application. As a result, the character and graphics data will not be distorted by the display rasterizing process.

The invention is applicable to all types of interactive TV applications, including electronic program guides (EPGs); character-intensive applications, such as news, sports/weather and other information services; graphics-intensive applications such as games; and enhanced TV applications, such as voting, polling, and the like, wherein video-plane characteristics may be used to adjust resolution.

In accordance with the invention, an interactive TV application may be developed for specific, pre-defined and known physical characteristics of target display devices. In such cases the native graphics resolutions, aspect ratios, sizes, display technologies, and other applicable physical display characteristics may be stored in templates accessible by a common executable module having further access to common data files and application/platform independent GUI resource files. Such implementation saves interactive application development and maintenance costs and bandwidth by broadcasting only one version of interactive TV application executable module designed to support multitude of known physical characteristics of target display devices.

### BRIEF DESCRIPTION OF THE DRAWINGS

FIG. 1 is a configuration diagram of digital TV service provider infrastructure components that include digital terminals without integrated displays according to the present invention;

FIG. 2 is a configuration diagram of digital TV service provider infrastructure components that include digital terminals with integrated displays according to the present invention;

FIG. 3 is a configuration diagram of digital TV service provider infrastructure components that include a combination of digital terminals with integrated displays;

FIGS. 4 and 5 provide examples of limited and known full screen video luminance resolutions for SDTV, EDTV and HDTV;

FIG. 6a shows examples of full screen video luminance resolutions for SDTV, EDTV and HDTV according ATSC specification;

FIG. 6b shows examples of the full screen video luminance resolutions for SDTV, EDTV and HDTV currently used in the North American market;

FIG. 6c shows examples of full screen OSD high resolutions for set-top-boxes currently deployed in the North American market;

FIG. 7 is a diagram of multi-resolution application according to the present invention;

FIGS. 8a, 8b, 8c, 8d are the examples of a Dynamic Mosaic Extended Programming Guide, DMXEPG, utilizing the present invention;

FIG. 9 is a logical diagram of a multi-screen application designed to support multi-resolution displays according to the present invention;

FIG. 10 is a diagram of GCET components;

FIG. 11 is a diagram of various languages that can be used to describe a platform-dependent application templates set;

FIG. 12 is a diagram of types of interactive applications development methods;

FIG. 13a is an example of device adaptable EPG application, which uses multiple platform-dependent application template sets;

FIG. 13b is an example of an electronic program guide (EPG) that is mis-matched to a device's display characteristics;

FIG. 13c is an example of device adaptable EPG application shown on the screen with a 16:9 aspect ratio;

FIG. 14 is a diagram of a unique font identifier and unique picture identifier;

FIG. 15 is a diagram showing different types of interactive TV applications;

FIG. 16 is a diagram of digital TV terminal resident interactive TV application software installation process for applications designed to support multiple display resolutions;

FIG. 17 is a diagram set-top-box resident interactive TV application software installation process for applications designed to support multiple display resolutions;

FIG. 18 is a diagram of initialization process of interactive TV applications stored or downloaded into the set-top box for applications designed to support multi resolution displays;

FIG. 19 is a diagram of an initialization process for interactive TV applications stored in the digital TV terminal for applications designed to support multi resolution displays;

FIG. 20 is a diagram of an initialization process for interactive TV applications downloaded into the digital TV terminal for applications designed to support multi resolution displays;

FIG. 21 is a diagram of control logic used by the application GUI decision-making module;

FIG. 22a is an example of four planes of a display;

FIG. 22b is an example of screen planes usage;

FIG. 23 is a diagram of a set-top box and display with a bi-directional data port used to exchange physical characteristics of display and if available its raster fonts;

FIG. 24 is a diagram showing connectivity between a set-top box and a display to transport video signal;

FIG. 25 is a diagram showing a digital TV terminal with an integrated display;

FIG. 26a is a diagram showing an OSD rendering algorithm according to the invention;

FIG. 26b is a diagram showing a currently used OSD rendering algorithm;

FIG. 27 is a diagram showing how a font rendering engine selects a rendering algorithm based on the information regarding target display's physical characteristics;

FIG. 28 shows a portion of a set-top box initialization process;

FIG. 29 is a diagram showing a continuation of the set-top box initialization process from FIG. 28;

FIG. 30 is a diagram showing DTV terminal initialization process;

FIG. 31a is a diagram showing rendering control flow for character data and graphics in accordance with the present invention;

FIG. 31b is a diagram showing rendering control flow for character data and graphics;

FIG. 32a is a diagram showing components and their size which are necessary for implementation of interactive TV application; and

FIG. 32b is a diagram showing components and their size which are necessary for implementation of interactive TV application to support multiple display resolutions and aspect ratios.

### DETAILED DESCRIPTION OF THE INVENTION

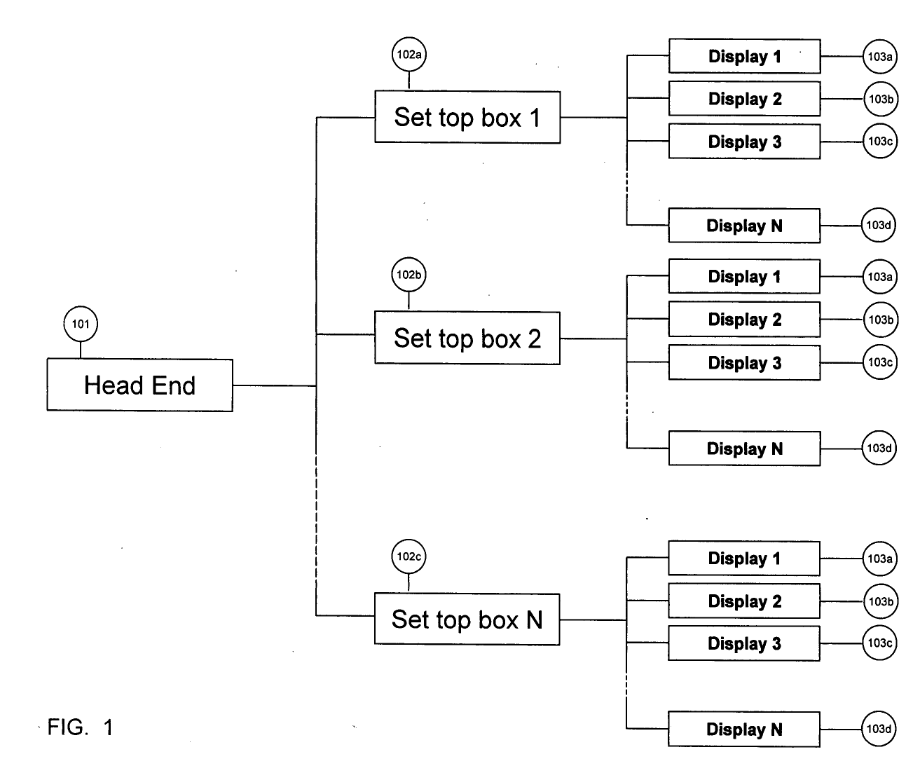

FIG. 1 is a configuration diagram of digital TV service provider infrastructure components that include digital terminals without integrated displays. The head end represents the head end of a Satellite, IPTV, TV over IP, Cable, or Digital Terrestrial service provider. The set top boxes can be of different types: middleware, conditional access, resolution, memory, CPU, etc. Each set top box can be connected to one or more display devices, each of which with a limited and known number of different physical parameters; i.e., native resolution, aspect ratio, screen size, display technology (CRT, LCD, OELD, Plasma, DLP), etc.

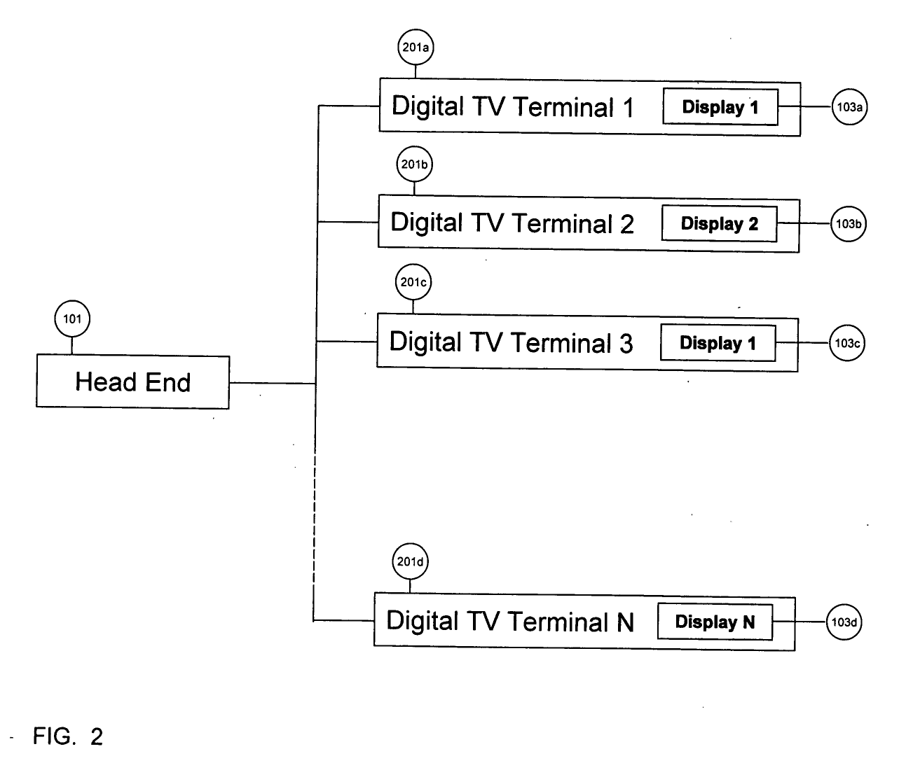

FIG. 2 is a configuration diagram of digital TV service provider infrastructure components that include digital terminals with integrated displays. The head end represents the head end of a Satellite, IPTV, TV over IP, Cable, or Digital Terrestrial service provider. The digital terminals can be of different types: middleware, conditional access, resolution, memory, CPU, etc, and have integrated display devices, each of which has a number of physical parameters: i.e., native resolution, aspect ratio, screen size, display technology (CRT, LCD, OELD, Plasma, DLP), etc.

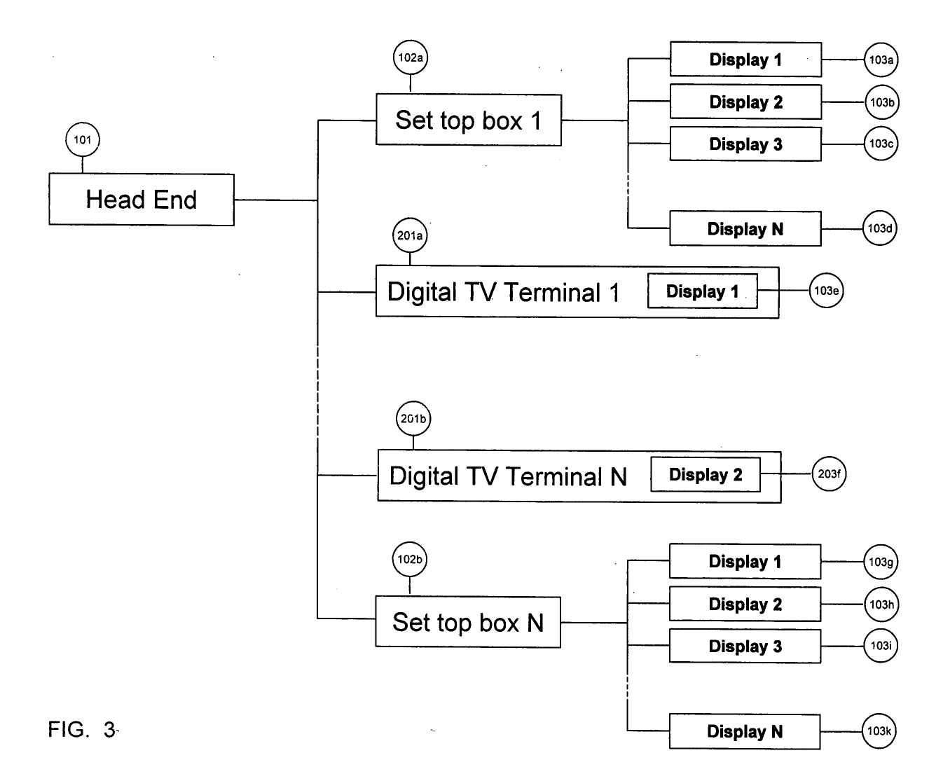

FIG. 3 is a configuration diagram of a digital TV service provider infrastructure components that include a combination of digital terminals with integrated displays, as well as set-top boxes connected to one or more display devices each of which with limited and known number of different physical parameters: native resolution, aspect ratio, screen size, display technology (CRT, LCD, OELD, Plasma, DLP), etc. The head end represents the head end of a Satellite, IPTV, TV over IP, Cable, or Digital Terrestrial service provider.

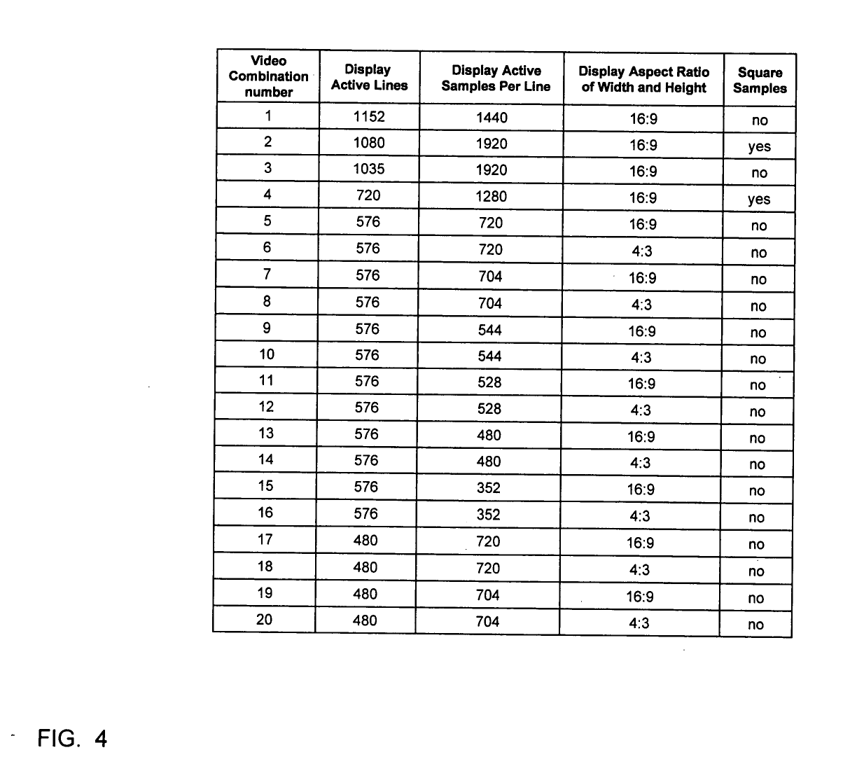

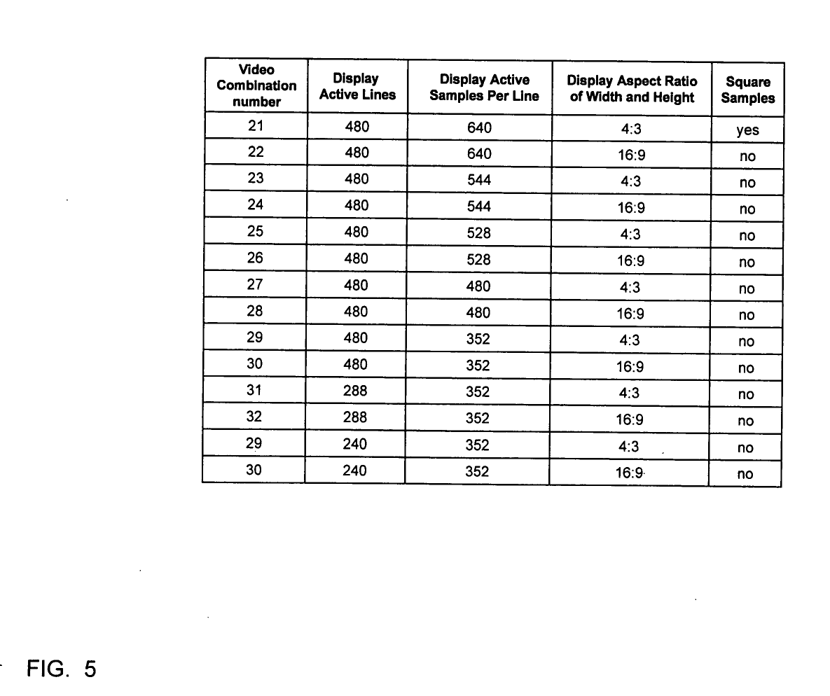

FIGS. 4 and 5 provide examples of limited and known full screen video luminance resolutions for SDTV, EDTV and HDTV (ETSI TR 101 154 v1.4.1 (2000-07)). For each combination number there is listed the number of active display lines, samples per line, aspect ratio, and whether or not square samples are used.

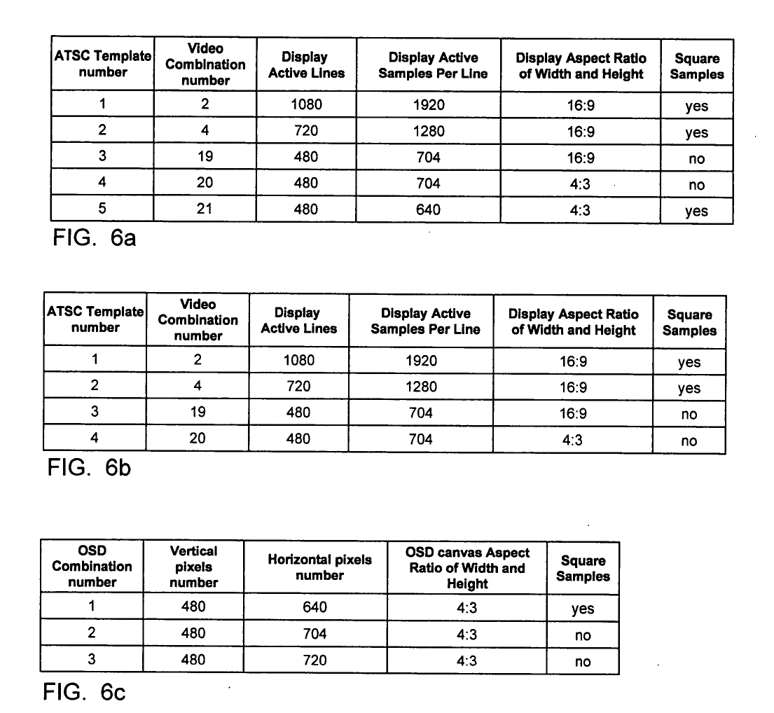

FIG. 6a shows examples of full screen video luminance resolutions for SDTV, EDTV and HDTV according ATSC specification. FIG. 6b shows examples of the full screen video luminance resolutions for SDTV, EDTV and HDTV currently used in the North American market. FIG. 6c shows examples of full screen OSD high resolutions for set-top-boxes currently deployed in the North American market.

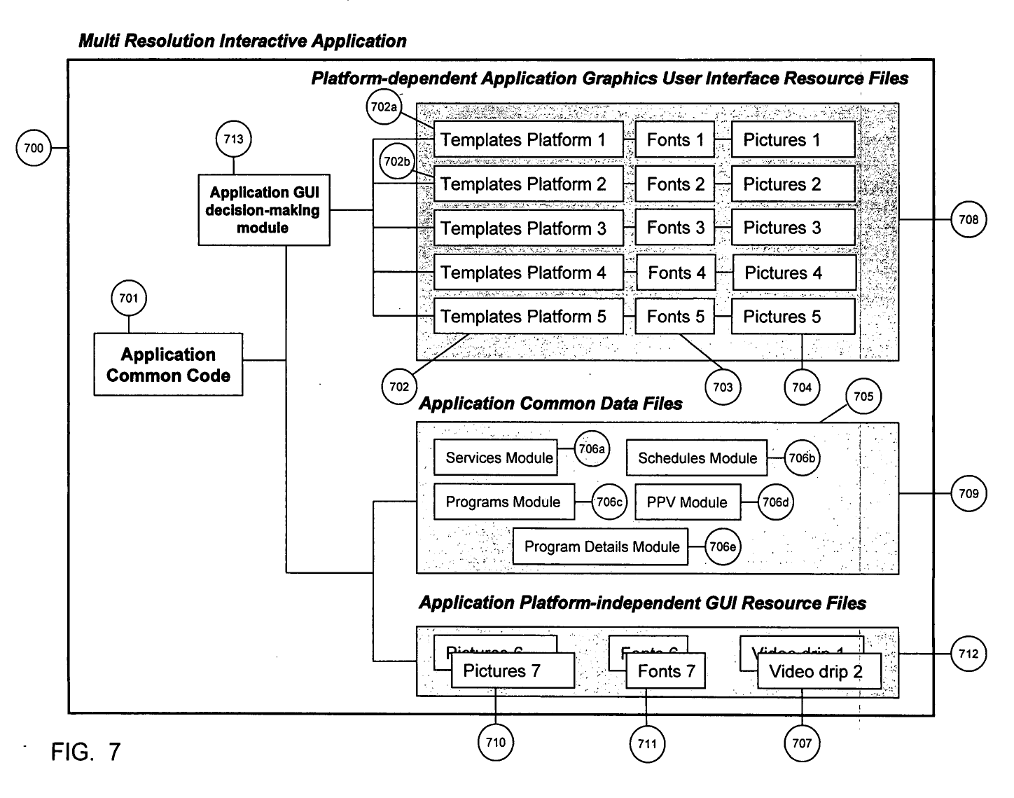

FIG. 7 is a diagram of multi-resolution application 700 according to the invention including the following elements:

Common application code (701);

Applications GUI resources files (708) designed to support specific Display/Set-top-box configuration. For each display/STB configuration, the application will have a set of configuration specific fonts (703), pictures (704) and application templates (702);

Application Common Data files (709): the common application data files/modules, which are used by Application for multiple Display/Set-top-box configurations; and

Application common GUI resource files (712): the common resources/modules files (e.g. pictures 710, fonts 711a, video drips 707), which are used by the application for multiple Display/Set-top-box configurations.

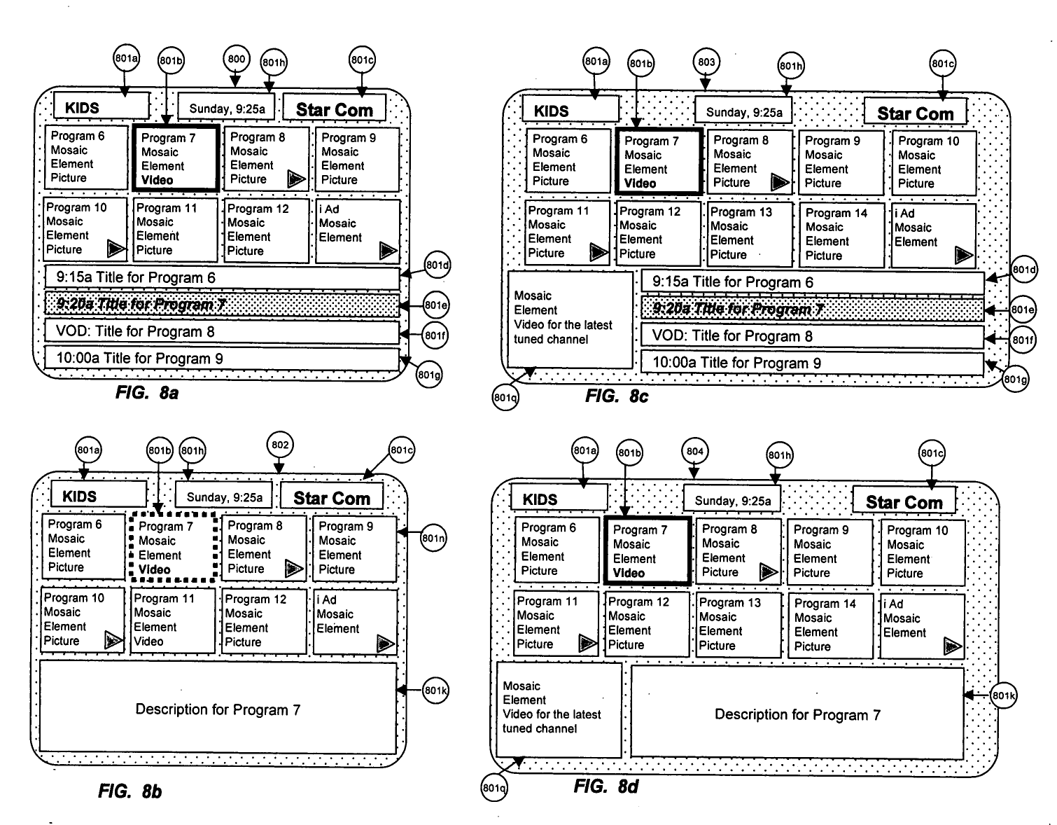

FIGS. 8a, 8b, 8c, 8d are the examples of a Dynamic Mosaic Extended Programming Guide, DMXEPG, utilizing the present invention. More details about the DMXEPG are found in co-pending U.S. patent application entitled “Dynamic Mosaic Extended Electronic Programming Guide for Television Program Selection and Display,” the entire content of which is incorporated herein by reference. Although the present invention is being described in conjunction with this novel DMXEPG guide, the invention is not limited in this regard and may be used with any system that would benefit from a more accurate program display.

FIGS. 8a and 8c show the same DMXEPG screen shown on displays with different resolutions and aspect ratios. FIGS. 8b and 8d show the same DMXEPG screen shown on displays with different resolutions and aspect ratios. In the case of FIG. 8d, the display has a wider aspect ratio with higher resolution. DMXEPG takes advantage of the output format by displaying, in accordance with user preferences, additional components such as video 801q and/or Mosaic Elements composed of an combination of pictures, text, animation, or video. Each DMXEPG screen includes the number of GUI Control Elements (801a-801q)—Program Title Element (801d, e, f, g), Picture Mosaic Element (801b, 801n), Program Descriptor Element (801k). Screen 800 uses DMXEPG Program List Screen Template for aspect ratio 4:3, OSD resolution 640:480. Screen 803 uses DMXEPG Program List Screen Template for aspect ratio 16:9, resolution 1080:720. Screen 802 uses DMXEPG Program Descriptor Screen Template for aspect ratio 4:3, resolution 640:480. Screen 804 uses DMXEPG Program Descriptor Screen Template for aspect ratio 16:9, resolution 1920:1080.

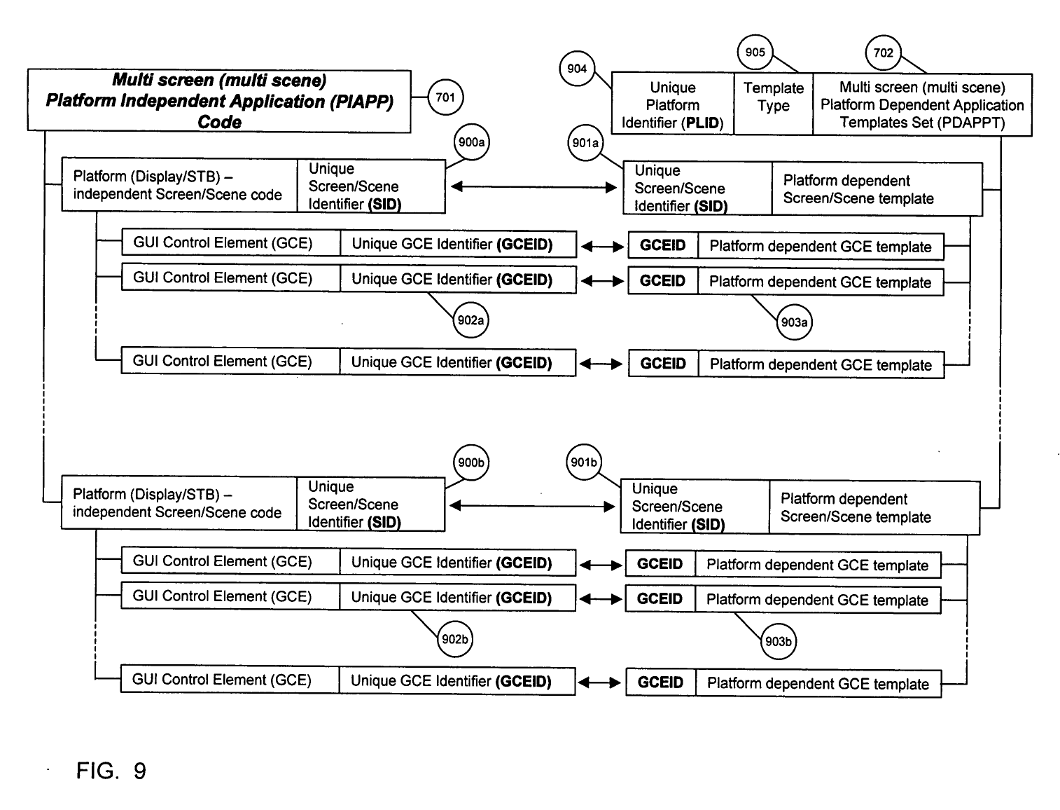

FIG. 9 is a logical diagram of a multi-screen application designed to support multi-resolution displays according to the present invention. Such support broadly includes:

a. Platform Dependent Application Template Set (PDAPPT) 702; and

b. Platform independent code 701

Each PDAPPT has a unique platform identifier (PLID) used by the application to select and access appropriate template set (702). Each PDAPPT includes platform-dependent Screens/Scenes templates. Each platform-dependent screen/scene template further includes a number of platform-dependent GCE templates (903a, 903b). Platform independent code 701 includes a number of screens/scenes (900a, 900b). Each screen has a unique identifier (SID) and includes a number of GUI Control Elements (GCE, 902a, 902b). Each GSE have a unique identifier (GCEID). Once started, the application selects appropriate platform dependent templates set (702) using PLID (chosen by the application's decision-making module 713). Using SID and GCEID, application retrieves platform-dependent templates from the Application Templates Set (702). It is important to note that PIAPP may adapt itself either in run-time (e.g. enhanced TV) or in build time (e.g. TV set specific EPG stored in the Digital TV set flash memory—one EPG code per multiple-resolutions displays). Template type 905 is used by the Application GUI decision-making module 713 to select appropriate PDAPPT 702 using user preferences (e.g. small/medium/large font size, distance to TV Display, etc.)

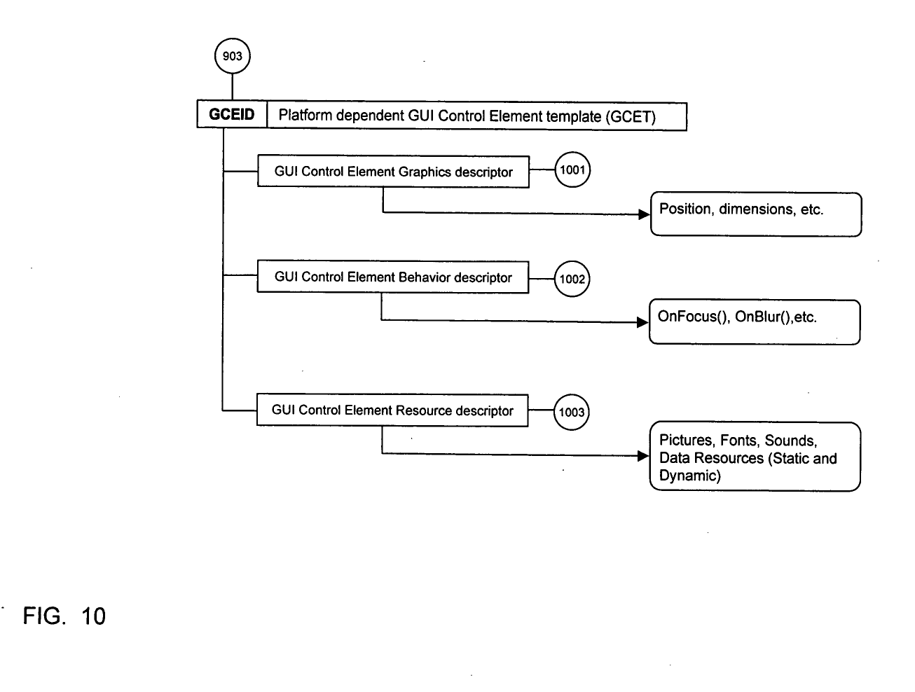

FIG. 10 is a diagram of GCET (903) components. The elements include a GUI control element graphics descriptor 1001 relating to position, dimensions, etc. A GUI control element behavior descriptor 1002 relates to on Focus( ), OnBlur( ), etc. A GUI control element resource descriptor 1003 relates to on Focus( ), OnBlur( ), etc.

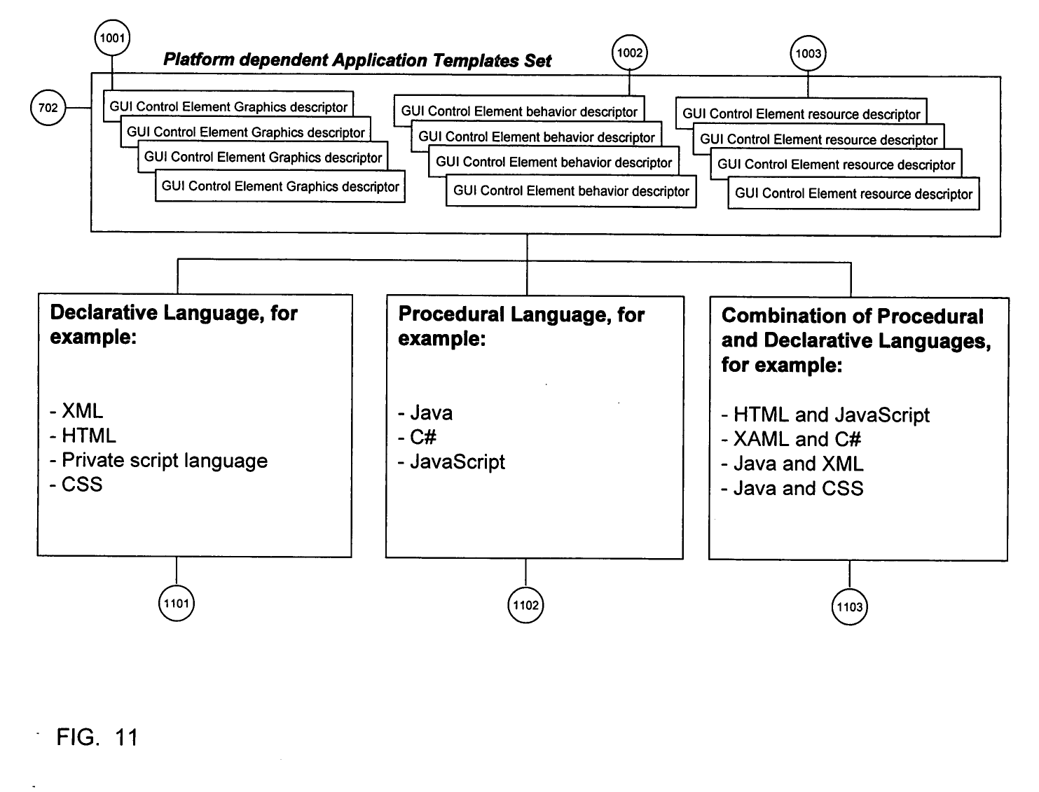

FIG. 11 is a diagram of various languages that can be used to describe a platform-dependent application templates set. Depending on application functionality and complexity, an application developer can use declarative language (1101), procedural language (1102), or a combination of procedural and declarative languages (1103).

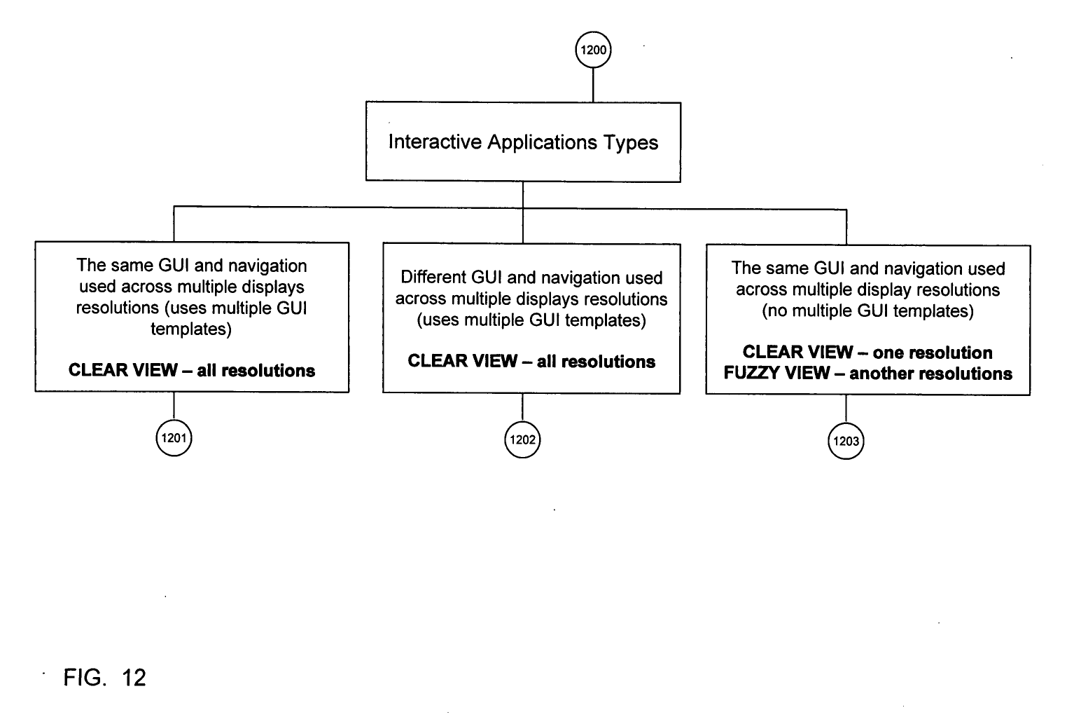

FIG. 12 is a diagram of types of interactive applications development methods. There are two method types:

a. Applications designed to support displays with various sets of physical characteristics (1201, 1202)

b. Applications designed to support a display with specific set of physical characteristics (1203)

There are two subtypes of applications designed to support displays with various physical characteristics:

a. Applications that look and feel (application navigation) the same on displays with various sets of physical characteristics(1201)

b. Applications that look and feel (application navigation) differently on displays with various sets of physical characteristics (1202)

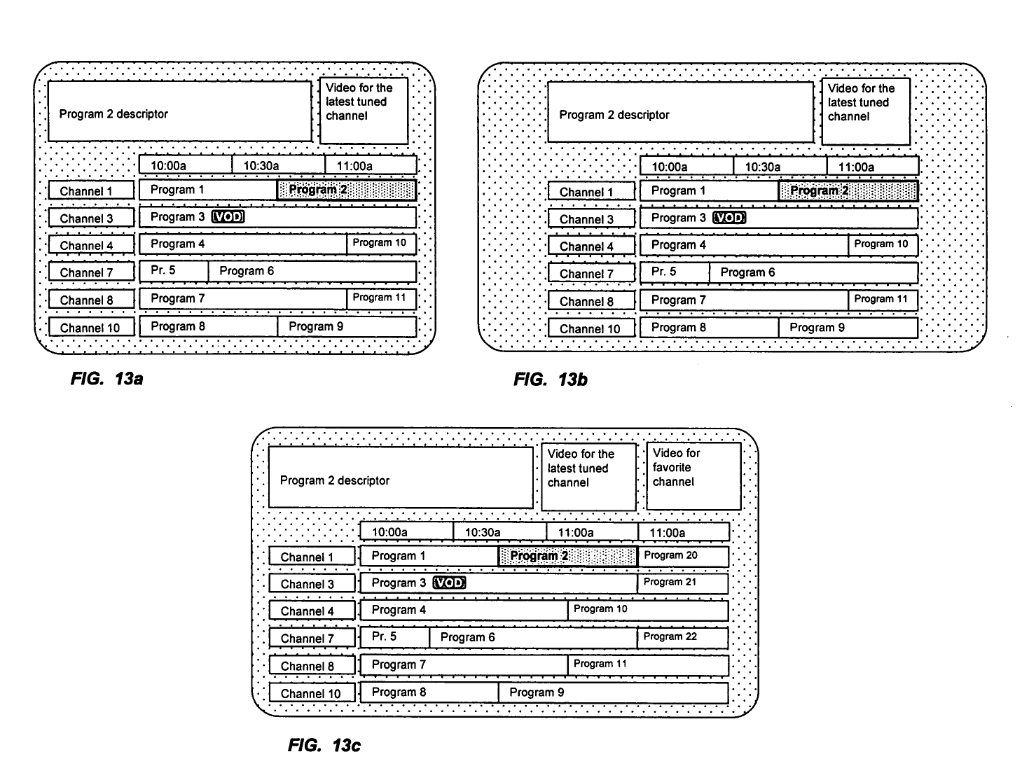

Applications designed to support a display with a specific set of physical characteristics (1203) shown on displays with different physical characteristics will always show less than ideal clarity of character data irrespective of type of scaling and algorithms use. This is due to the fact that such applications rely on a platform's automatic on-screen display (OSD) enlargement or reduction unit which does not takes into consideration application graphics user controls properties. As a result, the application displays “fuzzy” text (character data) and cannot utilize fully available display's canvas (FIG. 13b).

FIG. 13b is an example of an electronic program guide (EPG) that is mis-matched to a device's display characteristics, which was designed to support 4:3 display aspect ratio, but is displayed on a screen with a 16:9 aspect ratio. FIGS. 13a and 13c (type 1202) is an example of device adaptable EPG application, which uses multiple platform-dependent application template sets. FIG. 13c is an example of device adaptable EPG application shown on the screen with 16:9 aspect ratio. In contrast to FIG. 13b, the device adaptable EPG application fully utilized enlarged screen area by displaying additional elements and preserving full original quality of character data, using display specific fonts and display specific font rendering algorithms.

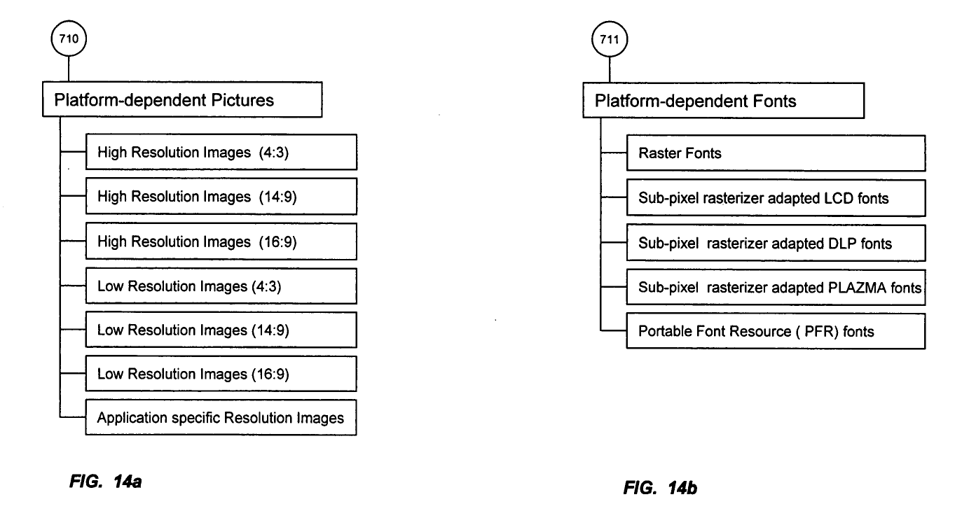

FIG. 14 is a diagram of Unique Font Identifier (711) and Unique Picture Identifier (710) which are used in the Platform dependent GUI Control Element template (GCET, 903), Platform dependent Screen/Scene template (901), and Multi screen (multi scene) Platform dependent Application Templates Set (702), all to achieve preservation of original graphics and character data quality on displays with different physical characteristics.

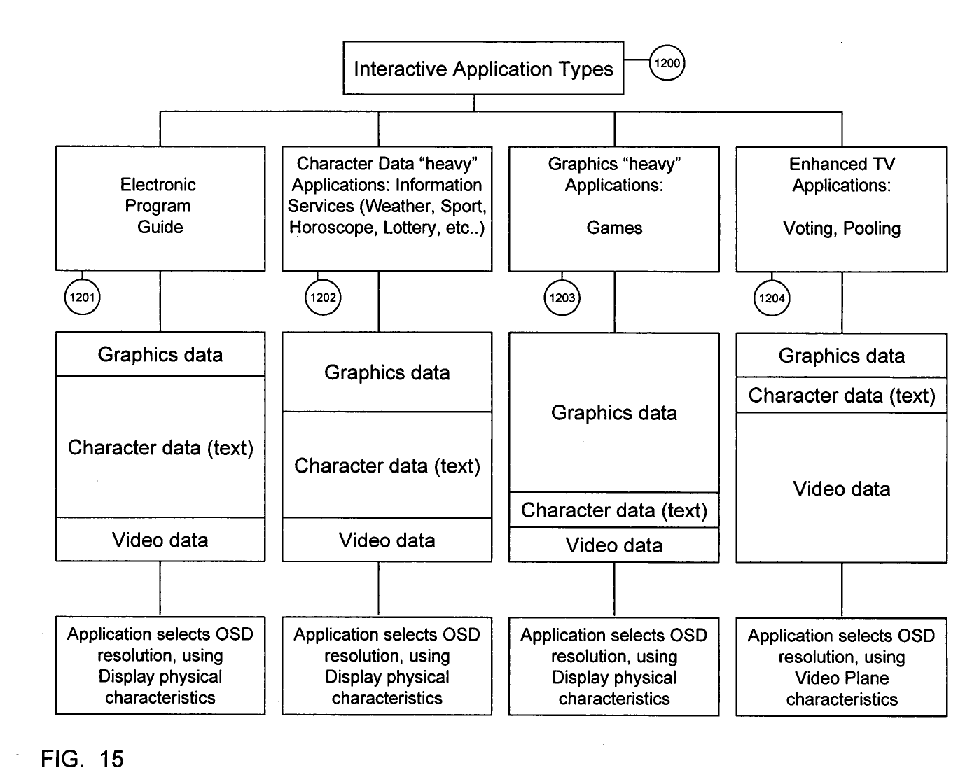

FIG. 15 is a diagram of different types of interactive TV applications, including those where the video occupies a predominant portion of the screen (1204), and others where graphical and character data elements occupy predominant portion of the screen (1201, 1202, 1203). Applications with graphics and character data elements occupying predominant portion of the screen are required to be shown in a native physical characteristic of the display to preserve original graphics and character data quality when shown on displays with different physical characteristics. As an example, these applications are:

1201—EPG

1202—Character data intensive applications. For example, horoscope, weather, sports, lottery, etc.

1203—Graphics intensive applications. For example, games, educational, gambling, etc.

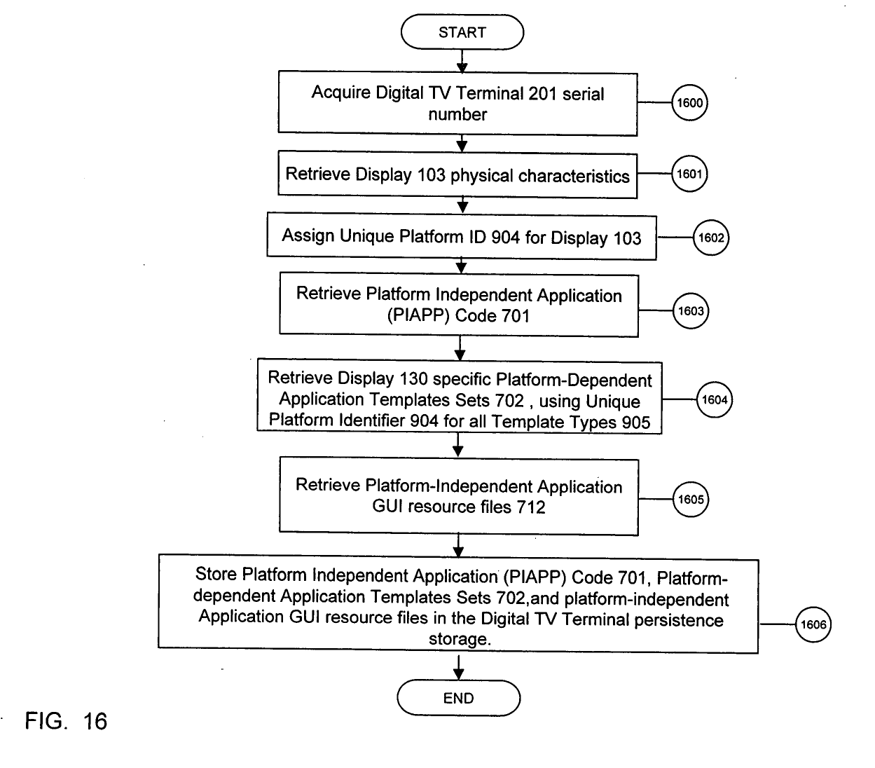

FIG. 16 is a diagram of Digital TV Terminal resident interactive TV application software installation process for applications designed to support multiple display resolutions 700. At step 1600 the serial number of digital TV terminal 201 is acquired. At 1601, display 103 physical characteristics are retrieved. A unique platform ID 904 for display 103 is assigned at 1602, and a platform independent application (PIAPP) code 701 is retrieved at 1603. Block 1604 retrieves display 130 specific platform-dependent application templates sets 702, using unique platform identifier 904 for all template types 905. At 1605, platform-independent application GUI resource files 712 are retrieved. Finally, at 1606 platform independent application (PIAPP) code 701, platform-dependent application templates sets 702, and platform-independent application GUI resource files are stored in the digital TV terminal persistence storage.

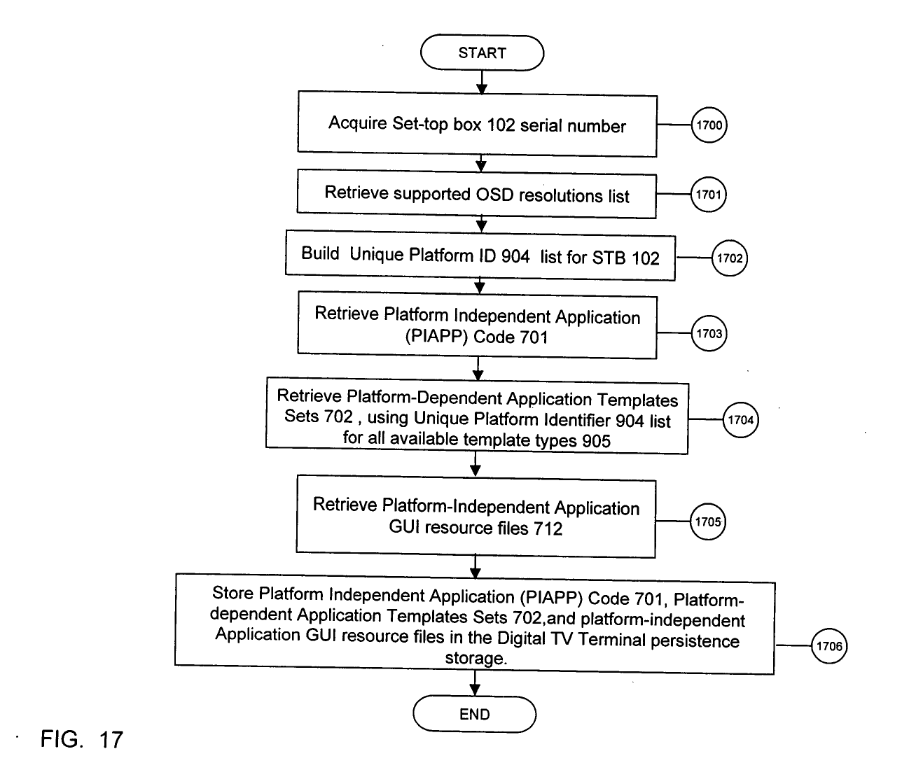

FIG. 17 is a diagram set-top-box 102 resident interactive TV application software installation process for applications designed to support multiple display resolutions 700. The set-top box 102 serial number is acquired at 1700, and at 1701 a supported OSD resolutions list is retrieved. A unique platform ID 904 list for STB 102 is built at 1702. Platform independent application (PIAPP) code 701 is retrieved at 1703. Block 1704 retrieve platform-dependent application templates sets 702, using unique platform identifier 904 for all available template types 905. Platform-independent application GUI resource files 712 are retrieved at 1705. Finally, platform independent application (PIAPP) code 701, platform-dependent application templates sets 702, and platform-independent application GUI resource files are stored in the digital TV terminal persistence storage.

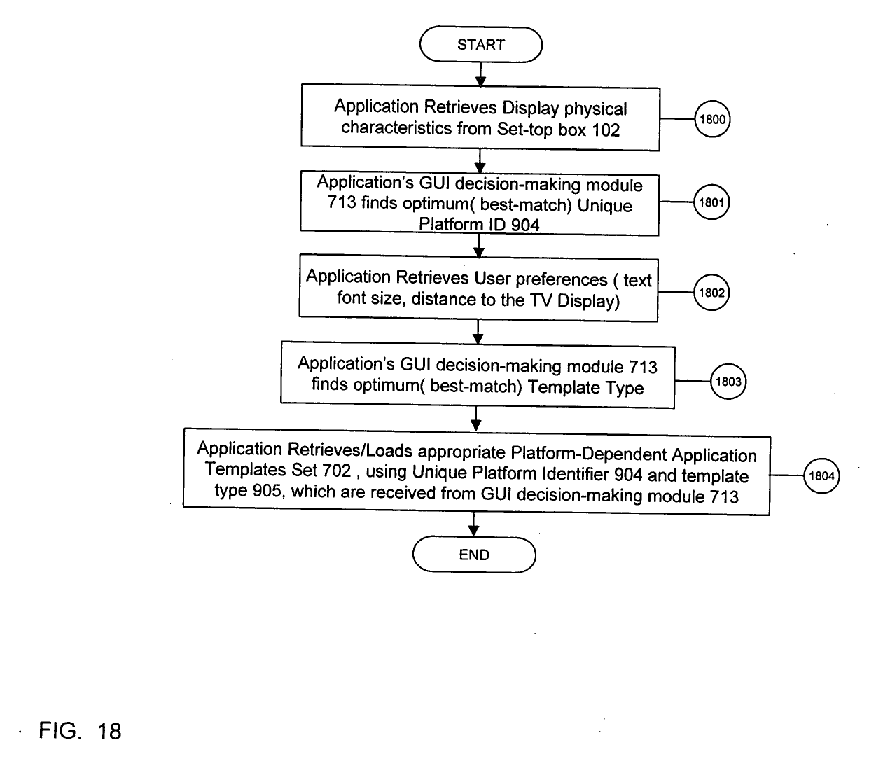

FIG. 18 is a diagram of initialization process of interactive TV applications stored or downloaded into the set-top box (102) for applications designed to support multi resolution displays. At 1800 the application retrieves display physical characteristics from set-top box 102. At 1801 the application's GUI decision-making module 713 finds optimum (best-match) unique platform ID 904. At 1802 the application retrieves user preferences (text font size, distance to the TV display). At 1803 the application's GUI decision-making module 713 finds optimum (best-match) template type. At 1804 application retrieves/loads appropriate platform-dependent application templates set 702 using unique platform identifier 904 and template type 905, which are received from GUI decision-making module 713.

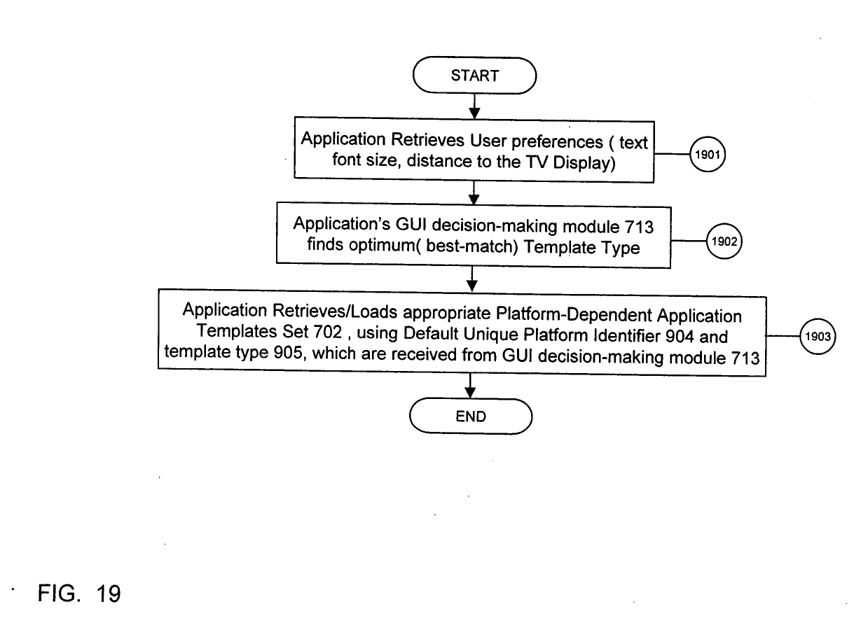

FIG. 19 is a diagram of initialization process of interactive TV applications stored in the Digital TV terminal 201 for applications designed to support multi resolution displays. At 1901 the application retrieves user preferences (i.e., text font size, distance to the TV display), etc. At 1902 the application's GUI decision-making module 713 finds optimum (best-match) template type. At 1903 the application retrieves/loads appropriate platform-dependent application templates set 702, using default unique platform identifier 904 and template type 905, which are received from GUI decision-making module 713.

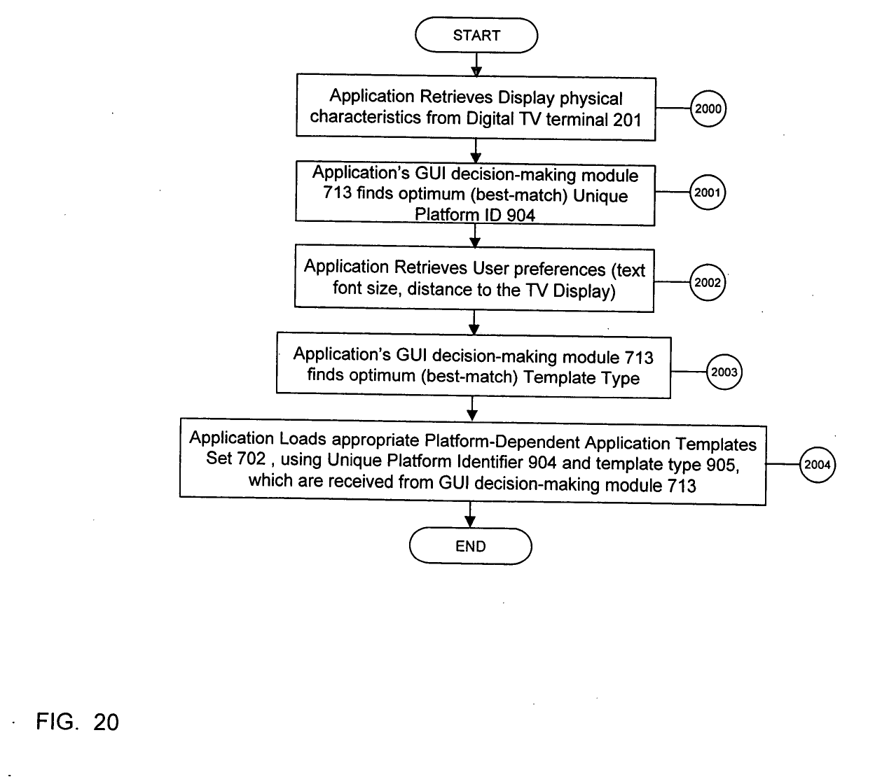

FIG. 20 is a diagram of initialization process of interactive TV applications downloaded into the Digital TV terminal 201 for applications designed to support multi resolution displays. At 2000 the application retrieves display physical characteristics from digital TV terminal 201. At 2001, the application's GUI decision-making module 713 finds optimum (best-match) unique platform ID 904. AT 2002 the application retrieves user preferences (i.e., text font size, distance to the TV display, etc.). At 2003 the application's GUI decision-making module 713 finds optimum (best-match) template type. At 2004 the application loads appropriate platform-dependent application templates set 702, using unique platform identifier 904 and template type 905, which are received from GUI decision-making module 713.

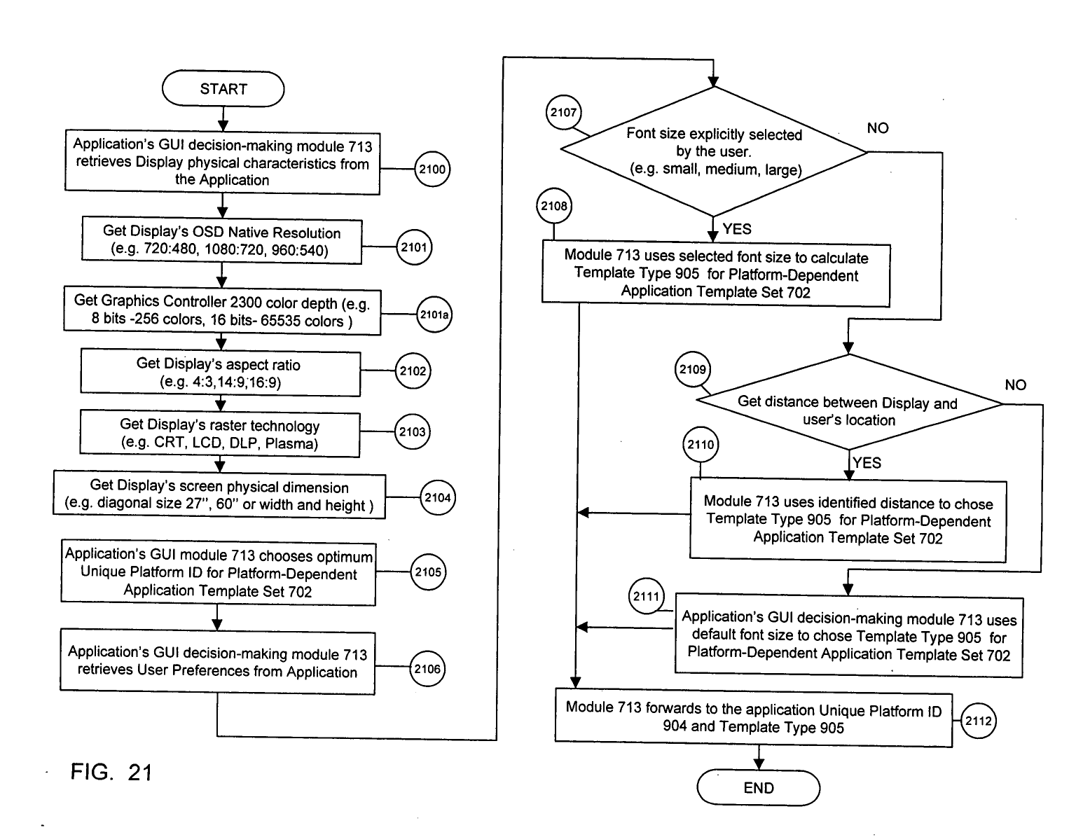

FIG. 21 is a diagram of control logic used by the Application GUI decision-making module. Its purpose is to choose combination of Unique Platform ID 904 and Template Type 905 for optimum display of graphics and character data on display with known and specific physical characteristics. At block 2100 the application's GUI decision-making module 713 retrieves display physical characteristics from the application. The display's OSD native resolution (e.g., 720:480, 1080:720, 960:540) are acquired at 2101. The graphics controller 2300 color depth (e.g., 8 bits -256 colors, 16 bits-65535 colors) is acquired at 2101a. The display's aspect ratio (e.g., 4:3, 14:9, 16:9) is acquired at 2102. The display's raster technology (e.g., CRT, LCD, DLP, plasma) is acquired at 2103. The display's screen physical dimension (e.g., diagonal size 27 inches, 60 inches, or width and height) is acquired at 2104. At 2105 the application's GUI module 713 chooses optimum unique platform ID for platform-dependent application template set 702. At 2106 the application's GUI decision-making module 713 retrieves user preferences from application. At 2107 font size is explicitly selected by the user (e.g., small, medium, large). At 2108 module 713 uses selected font size to calculate template type 905 for platform-dependent application template set 702. At 2109 the distance between display and user's location is determined. At 2110 module 713 uses the identified distance to choose template type 905 for platform-dependent application template set 702. At 2111 the application's GUI decision-making module 713 uses default font size to choose template type 905 for platform-dependent application template set 702, and finally, at 2112 module 713 forwards a unique platform ID 904 and template type 905 to the application.

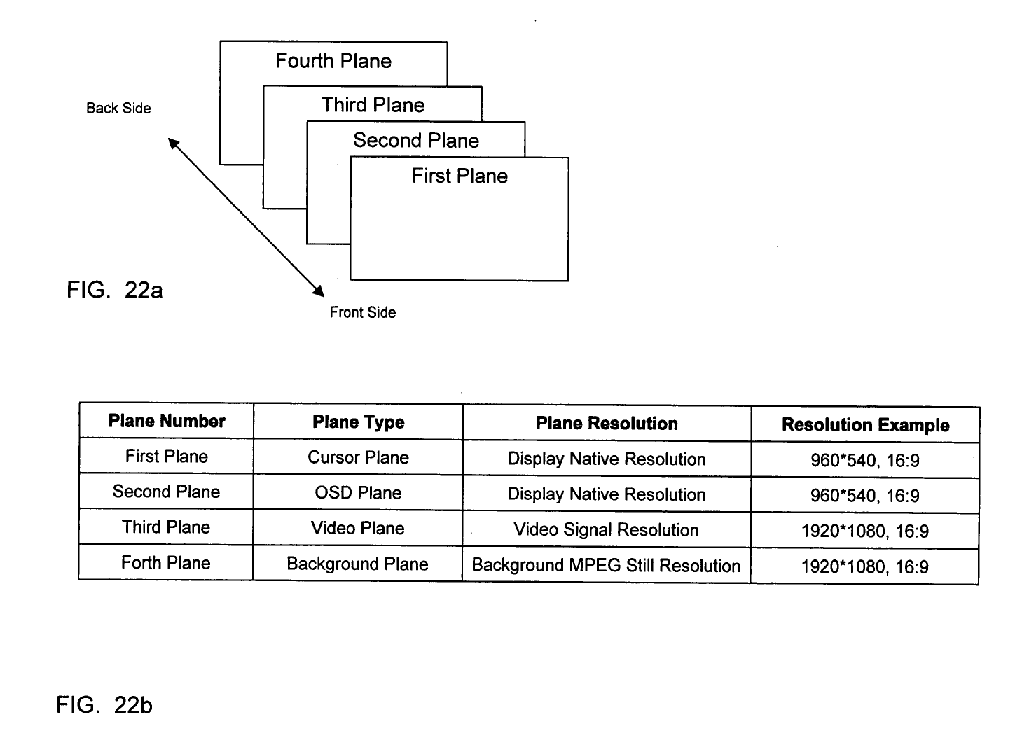

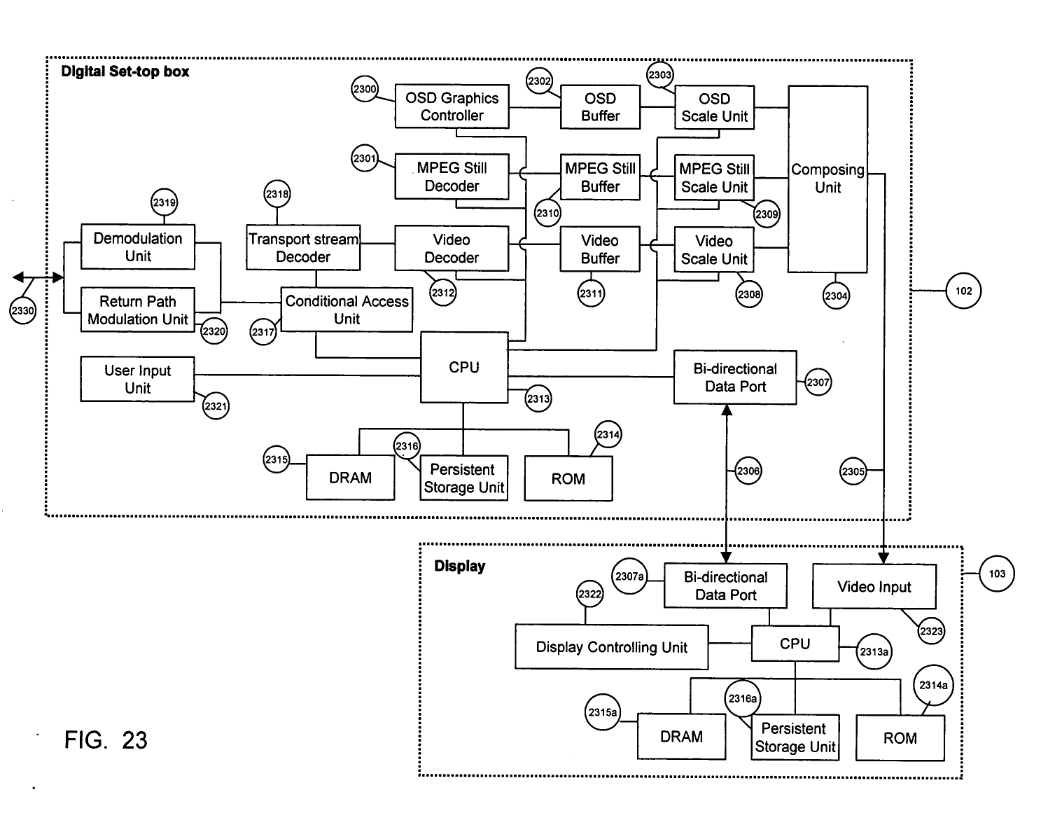

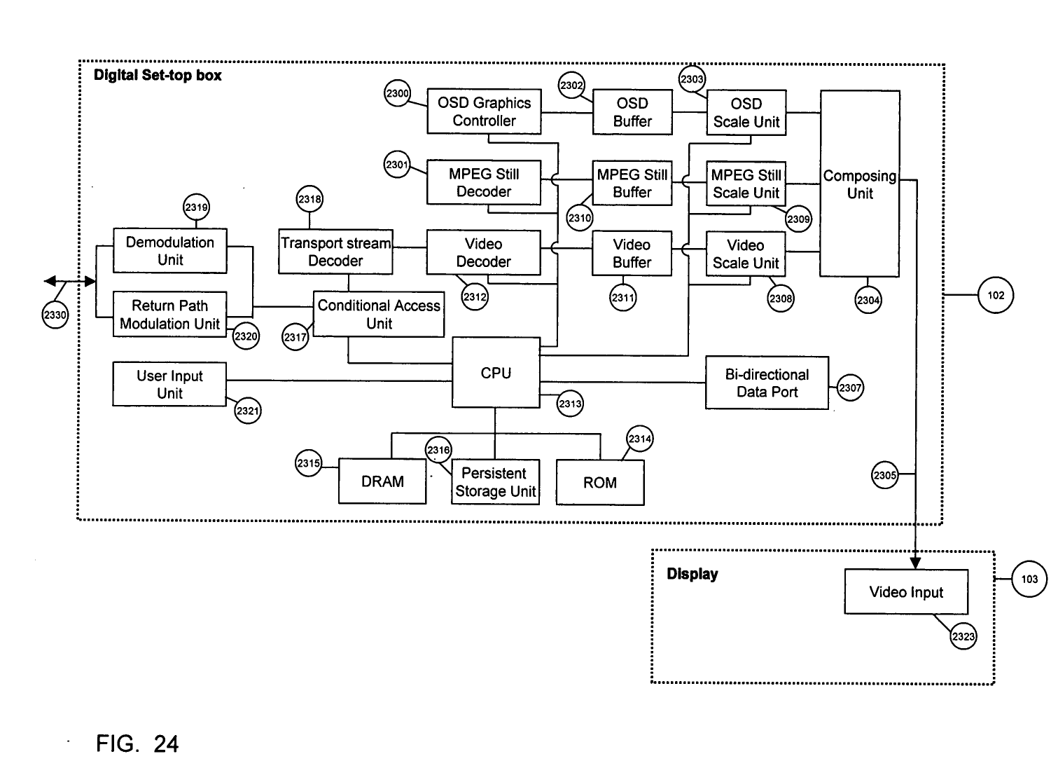

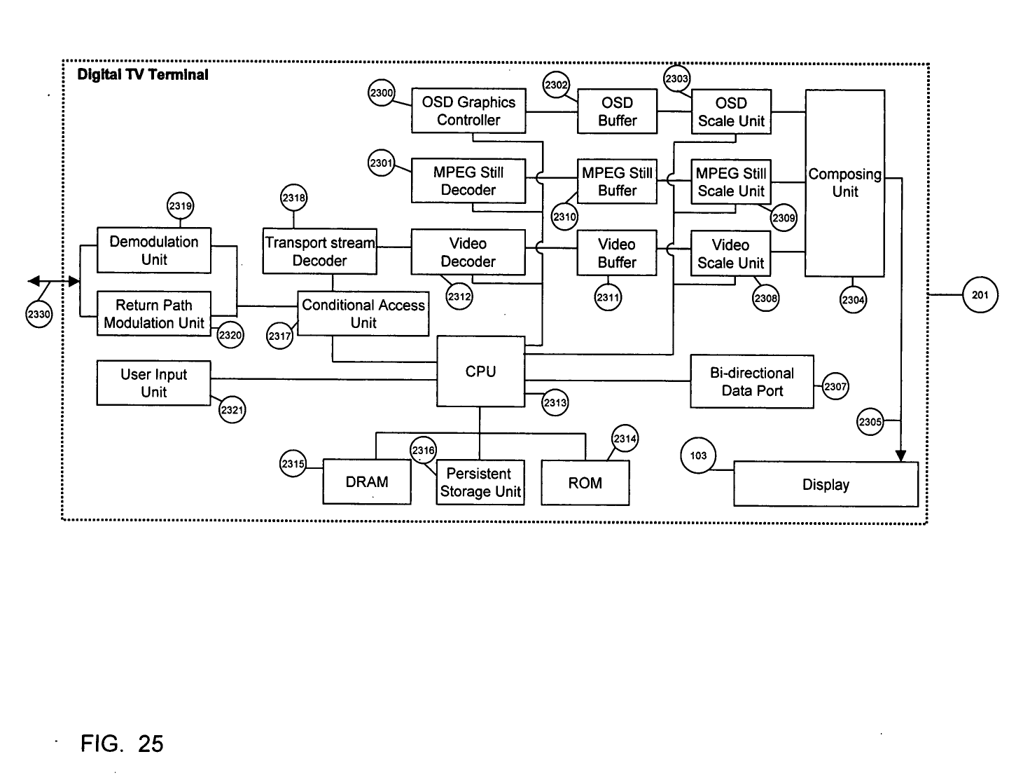

FIG. 22a shows an example of four planes of the display. FIG. 22b shows example of screen planes usage. FIG. 23 is a diagram of a Set-top box and Display with bi-directional data port used to exchange physical characteristics of display and if available its raster fonts. FIG. 24 is a diagram showing connectivity between set-top box 102 and display 103 to transport video signal. FIG. 25 is a diagram showing digital TV terminal 201 with integrated display.

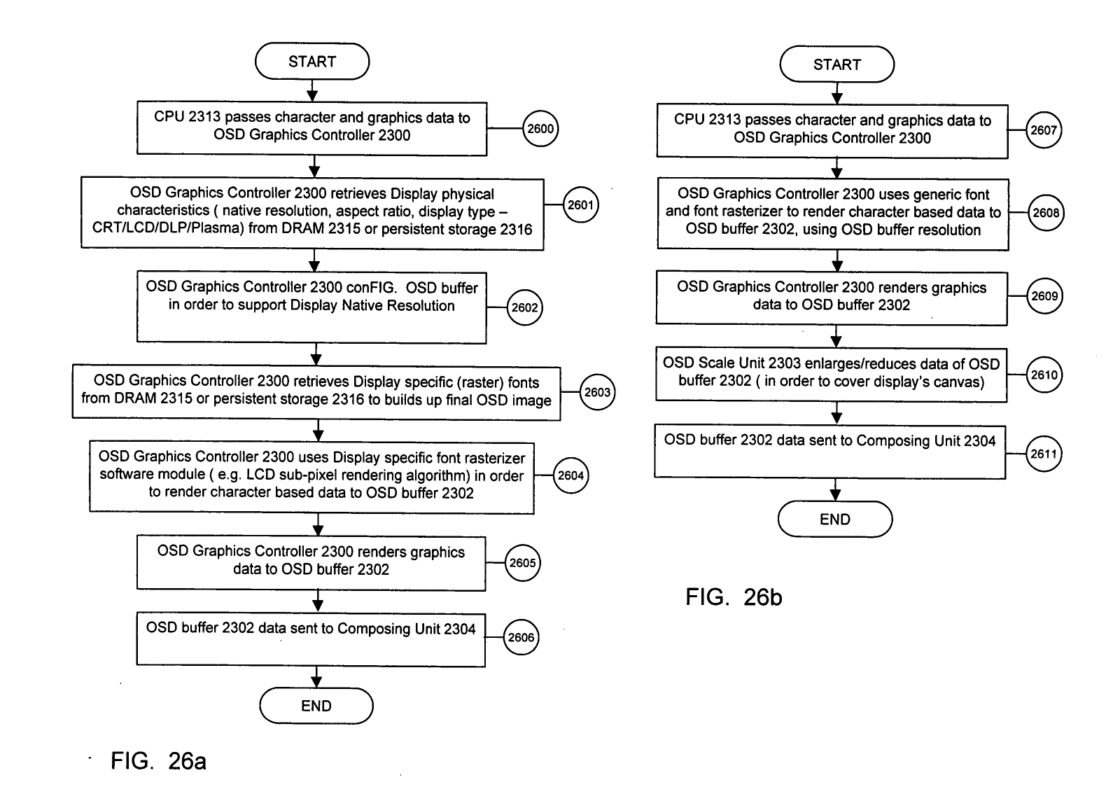

FIG. 26a is a diagram showing present invention's OSD rendering algorithm that enables interactive TV applications to preserve original graphics and character data quality on displays with different physical characteristics.

The inventive algorithm provides the capability to:

configure OSD buffer to support display's native resolution;

display specific raster fonts; and

display specific font rasterizing software.

FIG. 26b is a diagram showing currently used OSD rendering algorithm to illustrate the difference with rendering algorithms described in present invention. Step 2610 shows OSD Scale Unit 2303 enlarging/reducing OSD buffer 2302, using generic image scaling methods, which manipulate already rendered character text (step 2608) as an image. Product of currently used OSD rendering algorithm is a loss of original graphics and character data quality on displays with different physical characteristics.

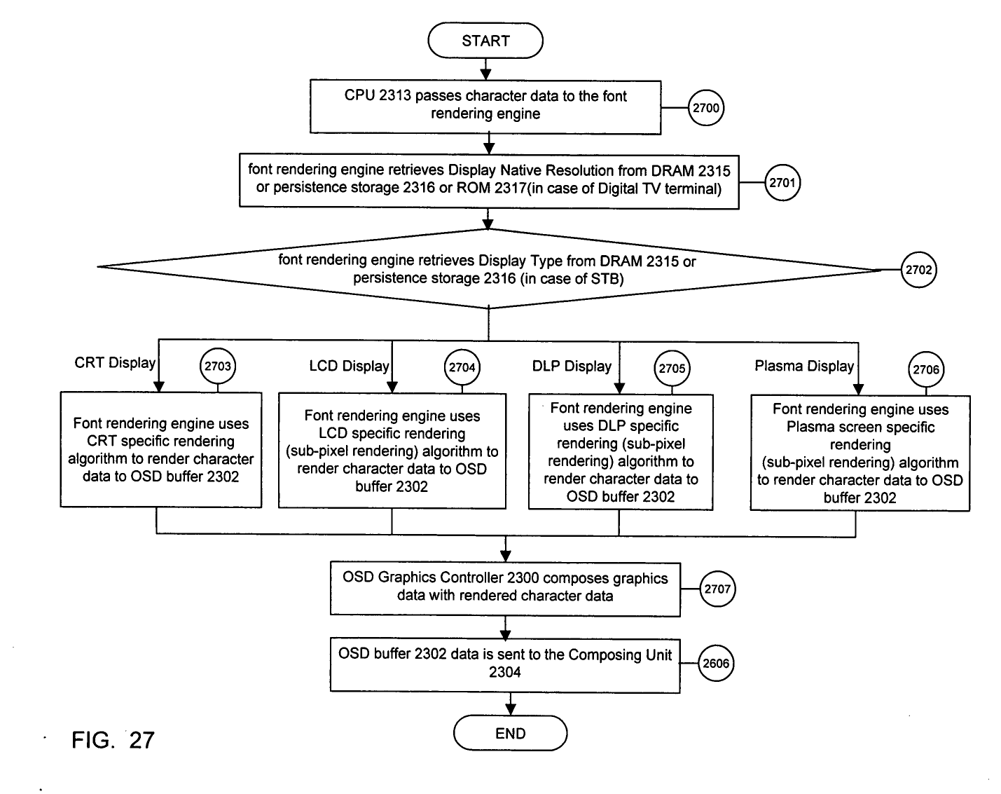

FIG. 27 is a diagram showing how in the present invention font rendering engine selects rendering algorithm based on the information regarding target display's physical characteristics.

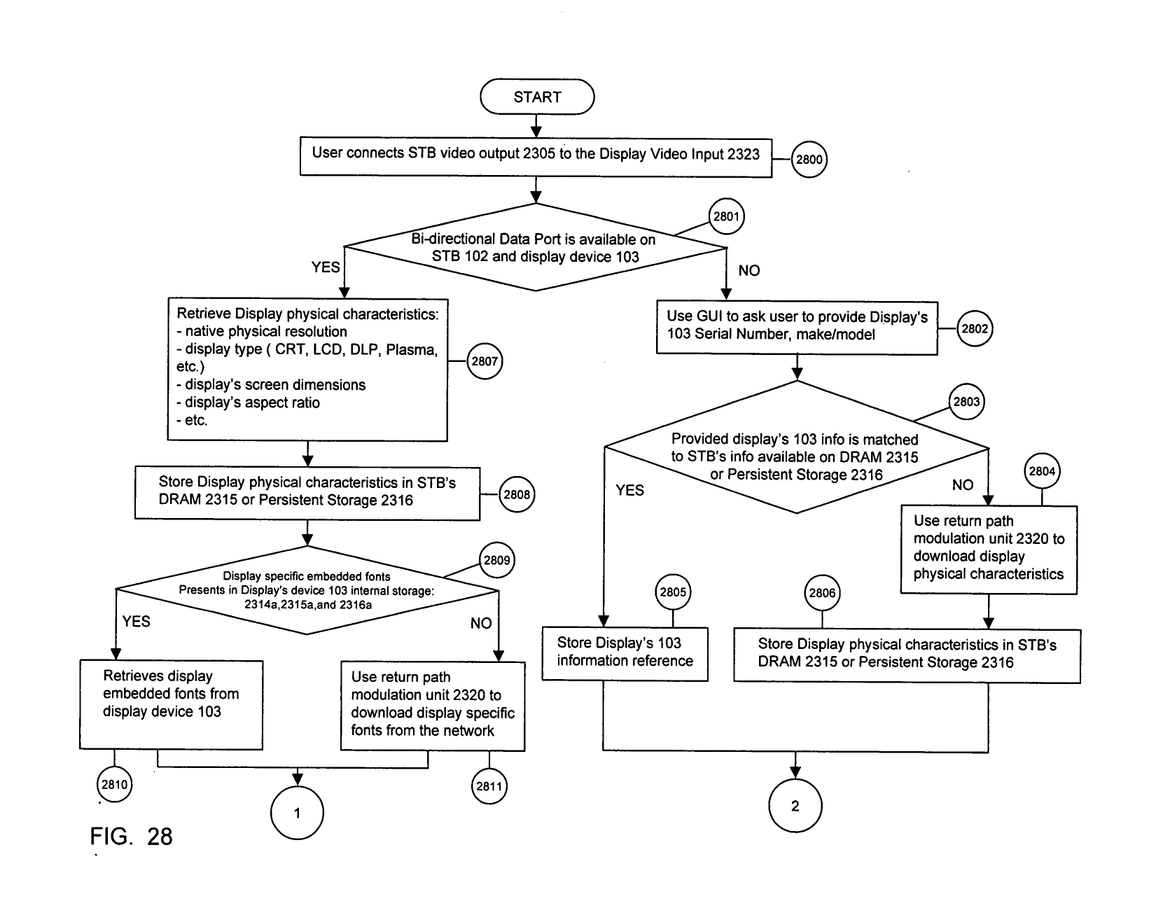

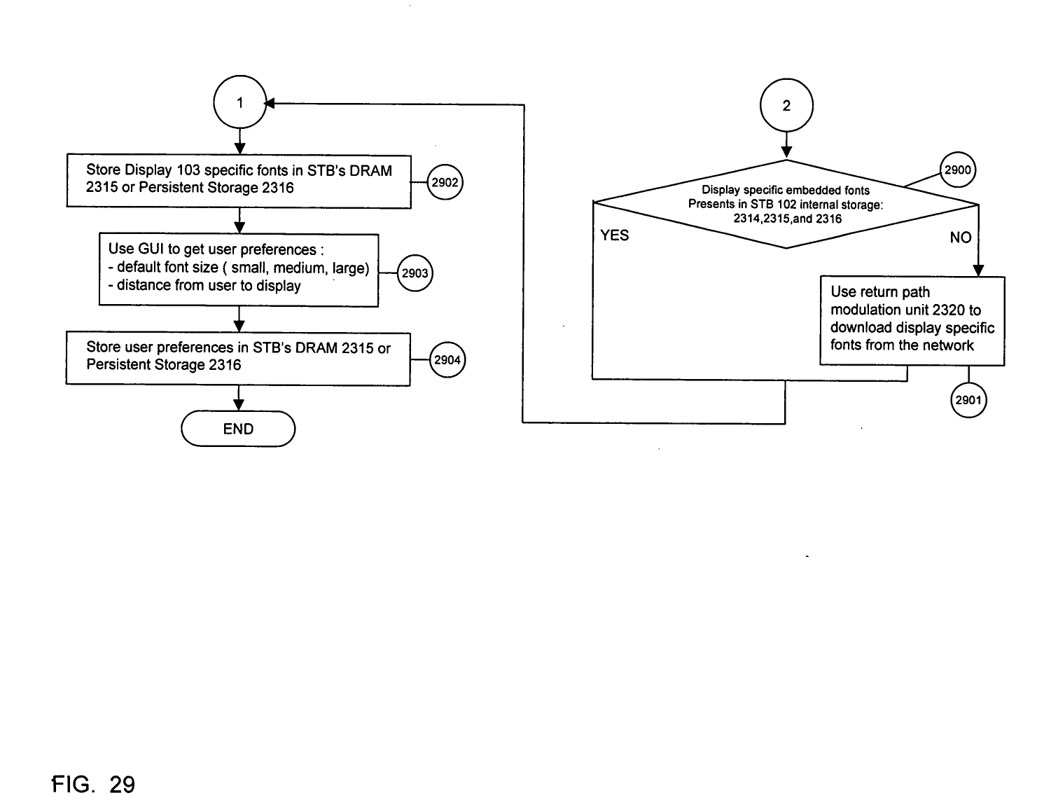

FIG. 28 and FIG. 29 are two diagrams showing portion of the set-top box 102 initialization process, in accordance with the present invention, that deals with the process of obtaining and using information regarding target display's physical characteristics connected for the first time with the purpose of optimizing interactive TV application's ability to preserve original graphics and character data quality on displays with different physical characteristics.

FIG. 29 is a diagram showing continuation of set-top box 102 initialization process from FIG. 28

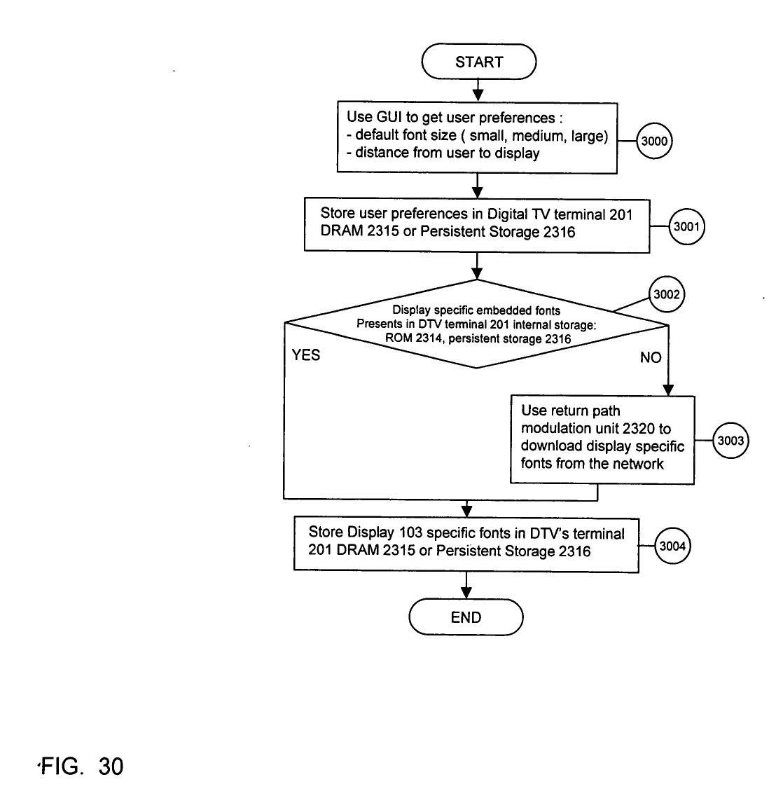

FIG. 30 is a diagram showing DTV terminal 201 initialization process that deals with the method of obtaining and using information regarding display's physical characteristics to optimize interactive TV application's ability to preserve original graphics and character data quality on displays with different physical characteristics.

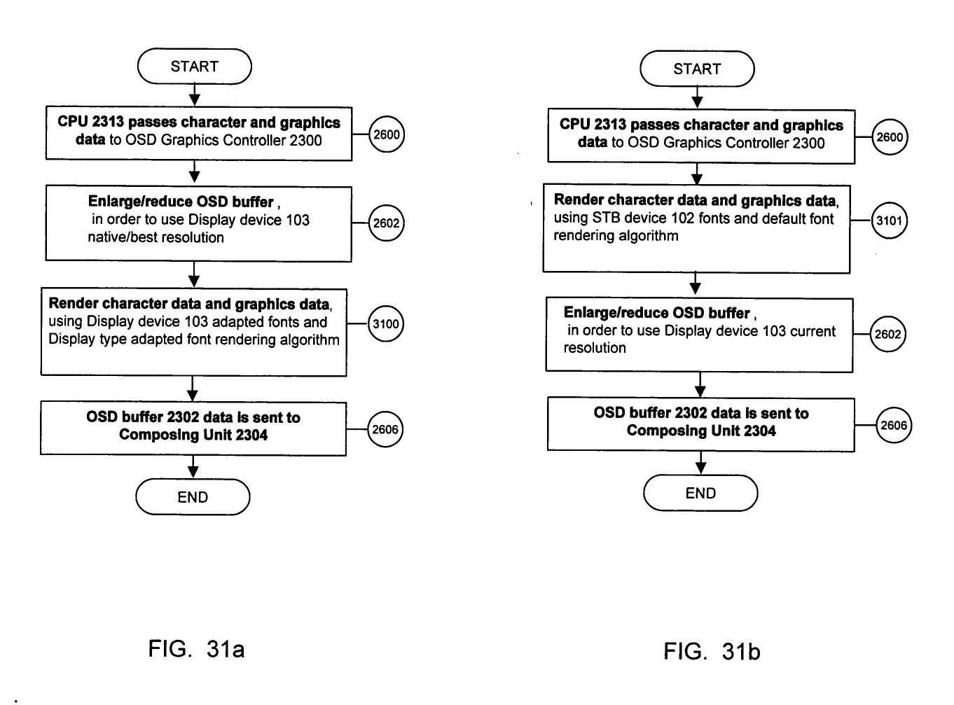

FIG. 31a is a diagram showing, in accordance with the present invention, rendering control flow for character data and graphics.

FIG. 31b is a diagram showing rendering control flow for character data and graphics, currently used. Size of each element relates to its code size in Kb. Common code base simplifies maintenance and debugging.

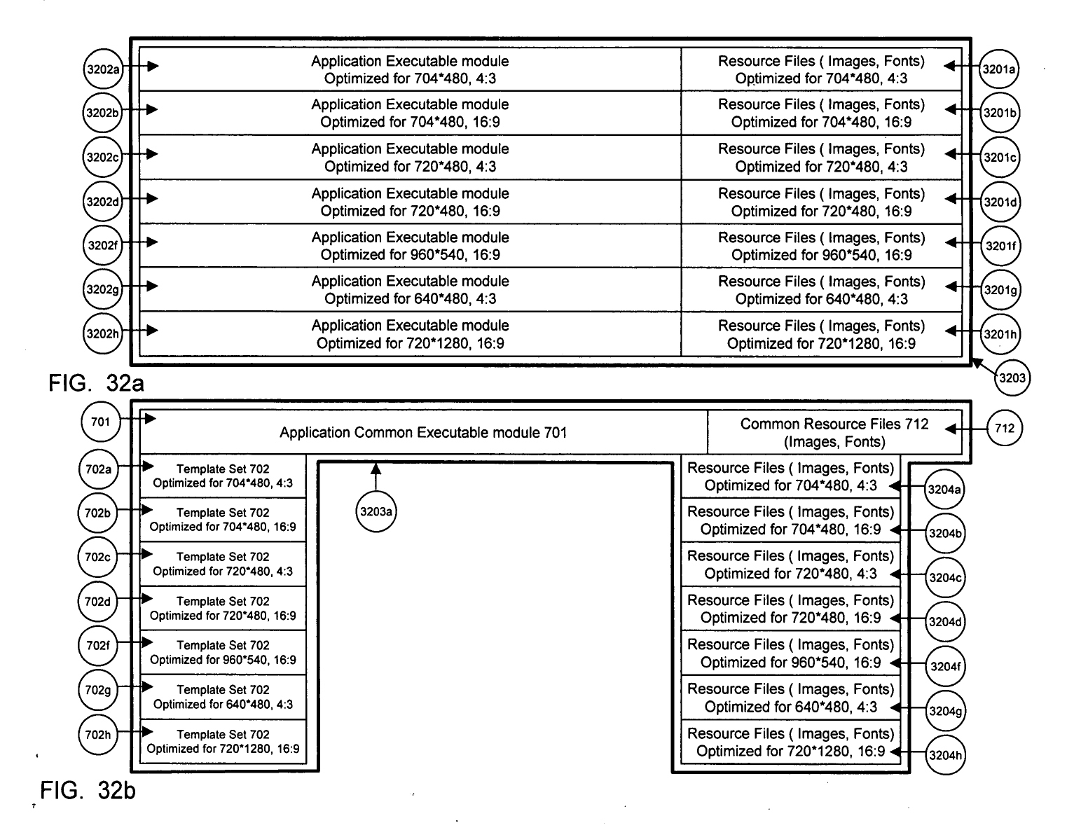

FIG. 32a is a diagram showing components and their size which are necessary for implementation of interactive TV application to support multiple display resolutions and aspect ratios using existing methods. These methods require separate application executable module 3202 and separate resource files for each display resolution/aspect ratio. The 3203 shows total allocated code size for this architecture.

FIG. 32b is a diagram showing, in accordance with the present invention, components and their size which are necessary for implementation of interactive TV application to support multiple display resolutions and aspect ratios. Because the size of Application Common Executable module 701 is almost the same as Application Executable Module 3202 and the size of template set is significantly smaller than Application Executable Module 3202, the total allocated size 3203a is significantly smaller than the total allocated size 3203 in FIG. 32a.

The use of an Application Common Executable module enables simplified and streamlined application design, testing, deployment, and maintenance across multiple target display devices; on one side providing outmost clarity in displaying graphical and character data elements of interactive TV application on displays with different resolutions and aspect ratios and at the same time not increasing significantly the cost and time necessary to create and deploy interactive TV applications designed to support displays with different resolutions and aspect ratios.

We claim:

1. A method of rendering an interactive television application on a display device having set of physical display characteristics, the method comprising the steps of:
providing an interactive television application including character data;
acquiring information regarding the physical display characteristics of the display device; and
rendering the character data of the interactive television application on the display device using the physical display characteristics.

2. The method of claim 1, wherein the physical display characteristics are matched to the native resolution of the display device.

3. The method of claim 1, wherein the interactive television application is an electronic program guide (EPG).

4. The method of claim 1, wherein the interactive television application provides news, weather, sports or other information services.

5. The method of claim 1, wherein the interactive television application is a game.

6. The method of claim 1, wherein the interactive television application includes graphical data, and the method further includes the steps of:
merging the graphical data with the character data; and
delivering the merged character and graphical data to the display device using the physical display characteristics.

7. The method of claim 1, wherein the interactive television application includes a video feed, and the method further includes the steps of:
merging the character data with the video feed; and
delivering the merged character data and video feed to the display device using the physical display characteristics.

8. The method of claim 1, wherein the step of rendering the character data involves the superposition of the character data onto a still or moving video display.

9. The method of claim 1, wherein the step of displaying the character data includes the use of fonts specific to the display device.

10. The method of claim 1, wherein:
the character data is stored in an on-screen display buffer; and
the on-screen display buffer is adjusted in accordance with the physical display characteristics.

11. The method of claim 1, wherein the display device forms part of a television receiver.

12. The method of claim 1, wherein at least some of the steps are performed in the display device.

13. The method of claim 1, wherein at least some of the steps are performed in a set-top box.

14. The method of claim 1, wherein at least some of the steps are performed at a head end.

15. The method of claim 1, wherein at least some of the steps are performed in conjunction with an initialization process.

16. The method of claim 1, wherein the step of acquiring information regarding the physical display characteristics includes receiving at least some of the physical display characteristics from the display device.

17. The method of claim 1, wherein:
the physical display characteristics are stored in advance in a plurality of templates, each template providing a set of physical display characteristics for a different display device; and
the application of a particular template is determined at least in part through a user selection process.

18. A method of rendering an interactive television application on a display device having set of physical display characteristics, the method comprising the steps of:
providing an interactive television application including a combination of character data and graphical data;
acquiring information regarding the physical display characteristics of the display device;
merging the character data and graphical data with background information in an on-screen buffer (OSB) using the physical display characteristics; and
rendering the interactive television application by transferring the contents of the OSB to the display device.

19. The method of claim 18, wherein the character data, graphical data, or both, are matched to the native resolution of the display device.

20. The method of claim 18, wherein the interactive television application is an electronic program guide (EPG).

21. The method of claim 18, wherein the interactive television application provides news, weather, sports or other information services.

22. The method of claim 18, wherein the interactive television application is a game.

23. The method of claim 18, wherein the:
interactive television application includes a video feed; and
the method further includes the steps of merging the video feed with the character and graphical data in the OSB.

24. The method of claim 18, wherein the background information is a still or moving video display.

25. The method of claim 18, wherein the physical display characteristics include one or more fonts specific to the display device.

26. The method of claim 18, wherein the display device forms part of a television receiver.

27. The method of claim 18, wherein the OSB is in the display device.

28. The method of claim 18, wherein the OSB is in a set-top box.

29. The method of claim 18, the OSB is at a head end.

30. The method of claim 18, wherein at least some of the steps are performed in conjunction with an initialization process.

31. The method of claim 17, wherein the physical display characteristics are received from the display device.

32. The method of claim 1, wherein:
the physical display characteristics are stored in a plurality of templates, each template providing a set of physical display characteristics for a different display device; and
the application of a particular template is determined through a user selection.

33. A method of rendering an interactive television application on a display device having set of physical display characteristics, the method comprising the steps of:
providing an interactive television application including a combination of character data, graphical data, and video feeds;
acquiring information regarding the physical display characteristics of the display device;
merging the character data and graphical data with background information in an on-screen buffer (OSB) using the physical display characteristics such that each video feed appears is a separate window; and
rendering the interactive television application by transferring the contents of the OSB to the display device.

34. The method of claim 33, wherein the character data, graphical data, or both, are matched to the native resolution of the display device.

35. The method of claim 33, wherein the interactive television application is an electronic program guide (EPG).

36. The method of claim 33, wherein the interactive television application provides news, weather, sports or other information services.

37. The method of claim 33, wherein the interactive television application is a game.

38. The method of claim 33, wherein the background information is a still or moving video display.

39. The method of claim 33, wherein the physical display characteristics include one or more fonts specific to the display device.

40. The method of claim 33, wherein the display device forms part of a television receiver.

41. The method of claim 33, wherein the OSB is in the display device.

42. The method of claim 33, wherein the OSB is in a set-top box.

43. The method of claim 33, the OSB is at a head end.

44. The method of claim 33, wherein at least some of the steps are performed in conjunction with an initialization process.

45. The method of claim 33, wherein the physical display characteristics are received from the display device.

46. The method of claim 33, wherein:
the physical display characteristics are stored in a plurality of templates, each template providing a set of physical display characteristics for a different display device; and
the application of a particular template is determined through a user selection.

47. A system for rendering an interactive television application on a display device having set of physical display characteristics, comprising:
an on-screen buffer (OSB);
at least one processor operative to perform the following functions in conjunction with the execution the interactive television application:
receive information regarding the physical display characteristics of the display device;
adjust the contents of OSB in accordance with the physical display characteristics; and
render the interactive television application by transferring the contents of the OSB to the display device.

48. The system of claim 47, wherein the physical display characteristics are matched to the native resolution of the display device.

49. The system of claim 47, wherein the interactive television application is an electronic program guide (EPG).

50. The system of claim 47, wherein the interactive television application provides news, weather, sports or other information services.

51. The system of claim 47, wherein the interactive television application is a game.

52. The system of claim 47, wherein:
the interactive television application includes graphical data; and
the processor is further operative to merge the graphical data with the character data in the OSB.

53. The system of claim 47, wherein:
the interactive television application includes one or more video feeds; and
the processor is further operative to merge the video feeds with the character data in the OSB.

54. The system of claim 47, wherein the processor is further operative to superimpose of the character data onto a still or moving video display.

55. The system of claim 47, wherein the processor is further operative to the use fonts specific to the display device.

56. The system of claim 47, wherein the display device forms part of a television receiver.

57. The system of claim 47, wherein the processor is located in the display device.

58. The system of claim 47, wherein the processor is located in a set-top box.

59. The system of claim 47, wherein the processor is located at a head end.

60. The system of claim 47, wherein the processor performs at least some of the steps in conjunction with an initialization process.

61. The system of claim 47, wherein the processor acquires information regarding the physical display characteristics from the display device.

62. The system of claim 47, further including:
a memory for storing the physical display characteristics in advance in a plurality of templates, each template providing a set of physical display characteristics for a different display device; and
the application of a particular template is determined at least in part through a user selection process.
